(19) United States
(12) Patent Application Publication
(10) Pub. No.: US 2026/0208249 A1
(43) Pub. Date: Jul. 23, 2026

(54) SIDE TRIMMING METHOD

(71) Applicant: ArcelorMittal, Luxembourg (LU)

(72) Inventor: Vikas PATEL, Naperville, IL (US)

(21) Appl. No.: 19/137,365

(22) PCT Filed: Dec. 13, 2023
(86) PCT No.: PCT/IB2023/062603

§ 371 Date: Jun. 10, 2025

(30) Foreign Application Priority Data
Dec. 14, 2022 (WO) PCT/IB2022/062193

(51) Int. Cl. B21B 15/00; B21B 45/00; B23D 19/06

(52) U.S. Cl. CPC B21B 15/0007; B21B 45/004; B23D 19/06; B21B 2015/0021

(57) ABSTRACT

A method for side trimming, along a cutting, a moving steel strip including a heating step, in which the cutting line is heated to a temperature above Ac1, and a trimming step, in which the steel strip is mechanically cut along the cutting line at a temperature above Ac1.

### BACKGROUND

The side trimming process refers to the cutting of a side of a material. In steel manufacturing, this operation is usually performed on steel strip after undergoing pickling operations in cold rolling lines or annealing treatment.

### SUMMARY OF THE INVENTION

This cut has several advantages. Firstly, it permits to achieve a uniform width for a steel strip according to the product application. Secondly, it guarantees the edge quality by removing irregular defects on the strip edges caused by upstream processes.

As illustrated in FIG. 1, the side trimming is done by a cutting unit 1 comprising a pair of trimming knives, an upper one 2 and a lower one 2′, on each side of a steel strip. The trimming knives, also called rotating knives, have a disc shape and are configured to rotate accordingly to the movement of the steel product. The knives have a thickness generally comprised between 20 and 40 mm.

The pair of knives defines a shear defined by two parameters: a gap ‘a’ and an overlap ‘b’. The gap is a horizontal distance between the two knives while the overlap is the vertical distance between the uppermost point of the lower knives and the lowermost point of the upper knife.

The steel product is cut, by shearing and tearing, at the edge portion by passing through the trimming knives. This operation generates wear and damage to the trimming knives, especially to their edge portions. Unfortunately, degraded trimming knifes can create flaws, such as cracks and/or burrs. This is the reason why the degraded trimming knifes are regularly replaced by one in good conditions. However, this replacement requires to stop the line thus reducing the line productivity.

Consequently, there is a need to extend the trimming knives lifespan to improve a line productivity.

EP 3 085 465 suggests adding a laser in front of the cutting unit, i.e. the trimming knifes, to preheat a portion of the steel product to be cut to a temperature from 400 to 600° C. This process permits to lower the yield strength of the steel strip due to the temperature increase.

This patent discloses that the temperature of the cut portion should not be lower than 400° C. otherwise the yield stress is not reduced enough, and it is impossible to reduce the shear load.

It also discloses that the temperature of the cut portion should not be higher than 600° C. otherwise a detrimental change in the material occurs due to a transformation after cooling.

It is an object of the present invention to provide a method extending the lifespan of trimming knife used for cutting a steel strip.

The present inventio provides a method for side trimming, along a cutting line, comprising a moving steel strip
i. a heating step wherein said cutting line is heated to a temperature above Ac1, and
ii. a trimming step wherein said steel strip is mechanically cut, along said cutting line, at a temperature above Ac1.

The cutting line refers to the portion of the strip undergoing the mechanical cut, where shearing and tearing forces are applied in the trimming step.

Ac1 represents the critical temperature at which pearlite transforms to austenite during heating. It can be defined with the following formula from Andrew:
Ac1 [° C.]=723−10.7Mn−16.9Ni+29.1Si+16.9Cr+290As+6.3W where Mn, Ni, Si, Cr, As and W are the content in weight percent of the corresponding element.

Contrary to the teaching of EP 3 085 465, in the present invention the cutting line is heated to a temperature greater than 600° C., i.e. greater than Ac1.

Surprisingly, the present inventors have discovered that the transformation after cooling was not detrimental as long as the temperature during the trimming is greater than Ac1. It could indeed have been expected that some hard phases would form on cooling, such phases being brittle in nature.

### BRIEF DESCRIPTION OF THE DRAWINGS

FIG. 1, already mentioned above, exhibits a shearing device as known in the state of the art.

FIG. 2 exhibits a side view of an embodiment of a shearing device according to the present invention.

FIG. 3 exhibits a top perspective view of the embodiment of FIG. 2.

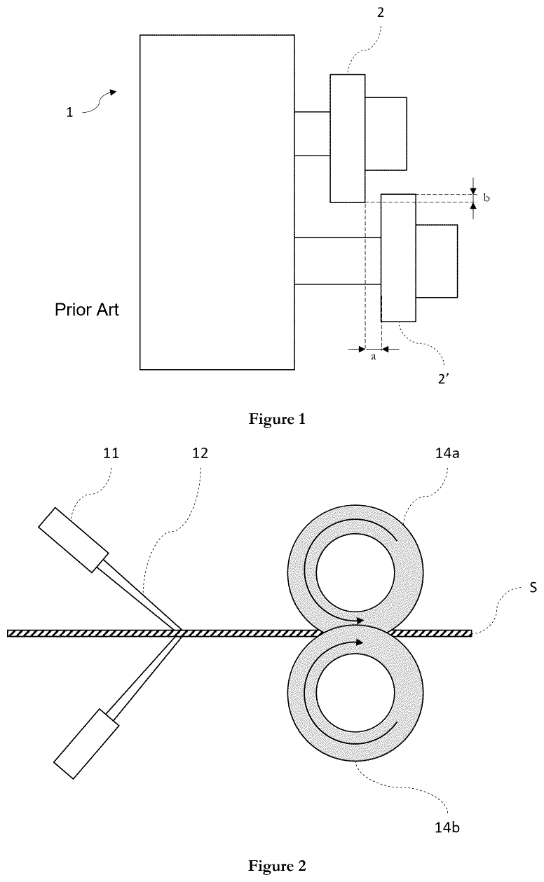

### DETAILED DESCRIPTION

Preferably, said steel is an advanced high strength steel (AHSS) having a tensile strength of at least 500 MPa. The AHSS family includes dual-phase (DP), dual phase-high ductility (DP HD), complex-phase (CP), complex phase-high ductility (CP HD), martensitic (MS), transformation-induced plasticity (TRIP), hot-formed (HF) and twinning-induced plasticity (TWIP) steels.

Preferably said strip steel is not a press-hardened steel strip.

Preferably, the heating is applied to the upper and lower faces of the strip.

Alternatively, the heating is applied to the upper face or the lower face. In that embodiment, the face opposite to the heated face is indirectly heated though heat transfer.

Preferably, during said heating step, no groove is formed. That means that the application of the heating does not lead to the formation of a groove at the location of the cutting line.

Preferably, in the heating step, said cutting line is heated to a temperature in the range of Ac1+10° C. to Ac3. Even more preferably, in the heating step, said cutting line is heated to a temperature in the range of Ac1+30° C. to Ac3.

Ac3 represents the final critical temperature at which free ferrite is completely transformed into austenite during heating. It can be estimated with the following formula:
Ac3 [° C.]=910−203 C^{1/2}−15.2Ni+44.7Si+104V+31.5Mo+13.1W−30Mn−11Cr−20Cu+700P+400AI+120As+400Ti, where C, Ni, Si, V, Mo, W, Mn, Cr, Cu, P, Al, As and Ti are the content in weight percent of the corresponding element.

Preferably, in the heating step, said cutting line is heated to a temperature above Ac3, and in the trimming step, said cutting line is mechanically cut at a temperature above Ac3. More preferably, said cutting line is heated to a temperature above Ac3+10°C. Even more preferably, in the heating step, said cutting line is heated to a temperature above Ac3+30° C.

Preferably, said heating is done by focusing a laser beam to said cutting line. Even more preferably, said laser beam produces a spot being controlled to have a circular shape, or a linear shape, or an oval shape.

Preferably, said side trimming is performed after a pickling operation of a cold rolling line. Preferably said side trimming is performed after an annealing treatment.

Hereinafter, an apparatus and a method for side-trimming a moving steel strip according to embodiments of the present invention will be described with reference to the attached drawings.

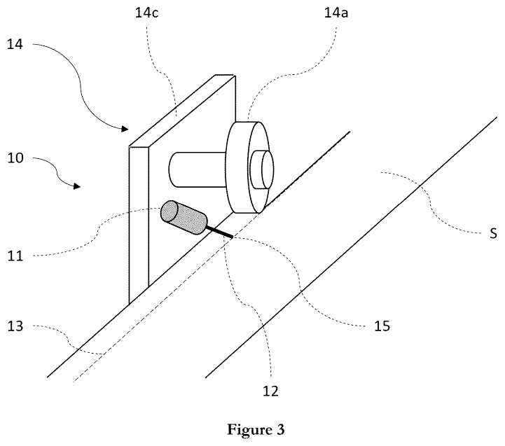

As illustrated in FIG. 3, the claimed process can be performed by a side trimming installation 10 comprising:
a laser processing unit 11 able to emit a laser beam 12 to the cutting line 13 of a steel strip S being conveyed to heat the cutting line 13; and
a cutting unit 14 installed on the periphery of a steel strip conveying path wherein said cutting unit is able to trim a side of a steel strip being conveyed through mechanical cutting.

In the heating step, as illustrated on FIG. 2, the laser processing unit is able to emit a laser beam to an upper face and to a lower face, along the cutting line, of the steel strip.

In this embodiment, the laser processing unit comprises a laser oscillator able to generate a laser beam and an optical condensing head able to focus said laser beam on said steel strip being conveyed. The laser beam 12 produces a spot 15 having a circular shape of the steel strip.

In the trimming step, as illustrated in FIG. 3, the steel strip S is mechanically cut along said cutting line 13 by a cutting unit 14. As illustrated in FIG. 2, the cutting unit 14 comprises an upper trimming knife 14a disposed above the strip conveying path and a lower trimming knife 14b disposed below the strip conveying path, i.e. the steel strip S. As represented on FIG. 3, the cutting unit 14 can also comprise a stand 14c rotatably supporting the upper and lower knives.

What is claimed is:

1-9. (canceled)

10. A method for side trimming, along a cutting line, a moving steel strip, the method comprising:
i. a heating step wherein the cutting line is heated to a temperature above Ac1, and
ii. a trimming step wherein the steel strip is mechanically cut along the cutting line at a temperature above Ac1.

11. The method as recited in claim 10 wherein the steel is an advanced high strength steel having a tensile strength of at least 500 MPa.

12. The method as recited in claim 10 wherein the heating is done by focusing a laser beam on the cutting line.

13. The method as recited in claim 12 wherein the laser beam produces a spot having a circular, linear or oval shape.

14. The method as recited in claim 10 wherein in the heating step, the cutting line is heated to a temperature in the range of Ac1+10° C. to Ac3.

15. The method as recited in claim 10 wherein in the heating step, the cutting line is heated to a temperature in the range of Ac1+30° C. to Ac3.

16. The method as recited in claim 10 wherein the strip steel is not a press-hardened steel strip.

17. The method as recited in claim 10 wherein the side trimming is performed after a pickling operation of a cold rolling line.

18. The method as recited in claim 10 wherein the side trimming is performed after an annealing treatment.
